(19) United States
(12) Patent Application Publication
(10) Pub. No.: US 2022/0083347 A1
(43) Pub. Date: Mar. 17, 2022

(54) ADDING CYCLE NOISE TO ENCLAVED EXECUTION ENVIRONMENT

(71) Applicant: Intel Corporation, Santa Clara, CA (US)

(72) Inventors: Scott Constable, Portland, OR (US); Bin Xing, Hillsboro, OR (US); Fangfei Liu, Hillsboro, OR (US); Thomas Unterluggauer, Hillsboro, OR (US); Krystof Zmudzinski, Forest Grove, OR (US)

(73) Assignee: Intel Corporation, Santa Clara, CA (US)

(21) Appl. No.: 17/019,880

(22) Filed: Sep. 14, 2020

(51) Int. Cl. G06F 9/4401; G06F 9/30

(52) U.S. Cl. CPC G06F 9/4418; G06F 9/30076

(57) ABSTRACT

A method comprises receiving an instruction to resume operations of an enclave in a cloud computing environment and generating a pseud-random time delay before resuming operations of the enclave in the cloud computing environment.

### BACKGROUND

In a cloud computing system, confidential information is stored, transmitted, and used by many different information processing systems. An enclaved execution environment (EEE) is a category of hardware-facilitated secure containers in a cloud computing system. In some examples a processing device such as a central processing unit (CPU) can use techniques including encryption, custom memory access semantics, integrity checking, and cryptographic attestation schemes to construct one or more enclaves (i.e., an enclave is an instance of an EEE). Each enclave shields one or more user applications from other enclave applications, non-enclave applications, and even privileged software such as the OS or parent hypervisor. Hence the trusted computing base (TCB) of a given enclave consists solely of the enclave itself and the underlying hardware that facilitates enclave isolation (i.e., the CPU).

Since enclaves must share resources, including memory and execution units, with the rest of the system, most EEEs support preemptive scheduling, which inhibits enclaves from monopolizing system resources. However, in some examples it may be possible for operating systems and hypervisors to abuse their privilege to execute an enclave in small increments and strategically extract secret data from the enclave through one or more side channels. These side channel attacks area form of side-channel attacks collectively referred to as interrupt-driven attacks.

Accordingly, systems and techniques to address such attacks may find utility, e.g., in enhancing security for cloud computing systems.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a schematic illustration of a processing environment in which systems and methods in which adding cycle noise to an enclaved execution environment may be implemented, according to embodiments.

FIG. 2 is a simplified block diagram of an example system including an example platform which supports adding cycle noise to an enclaved execution environment in accordance with an embodiment.

FIG. 3 is a simplified block diagram representing application attestation in accordance with one embodiment.

FIG. 4 is a simplified, high-level flow diagram of at least one embodiment of a method for adding cycle noise to an enclaved execution environment according to an embodiment.

FIGS. 5A-5B are diagrams illustrating instruction execution operational flows in various examples of a method for adding cycle noise to an enclaved execution environment according to an embodiment.

FIG. 6 is a block diagram illustrating a computing architecture which may be adapted to provide a method for adding cycle noise to an enclaved execution environment according to an embodiment.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C) Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Example Cloud Computing Environment with Trusted Execution

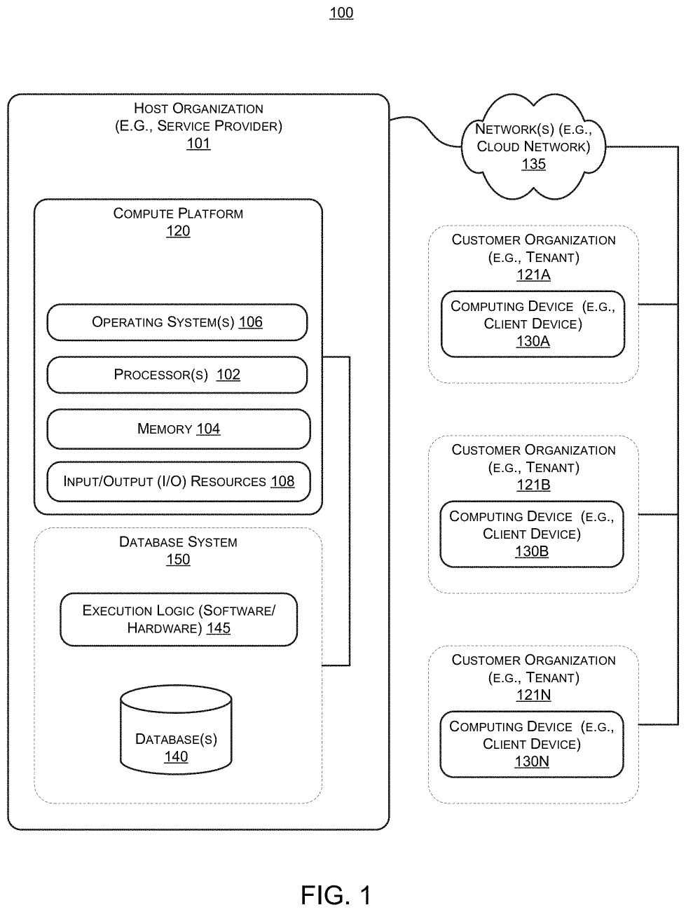

FIG. 1 is a schematic illustration of a processing environment in which systems and methods for trusted execution aware hardware debug and manageability may be implemented, according to embodiments. Referring to FIG. 1, a system 100 may comprise a compute platform 120. In one embodiment, compute platform 120 includes one or more host computer servers for providing cloud computing services. Compute platform 120 may include (without limitation) server computers (e.g., cloud server computers, etc.), desktop computers, cluster-based computers, set-top boxes (e.g., Internet-based cable television set-top boxes, etc.), etc. Compute platform 120 includes an operating system (“OS”) 106 serving as an interface between one or more hardware/physical resources of compute platform 120 and one or more client devices 130A-130N, etc. Compute platform 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile compute platforms, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated database system 150 includes database(s) 140 to store (without limitation) information, relational tables, datasets, and underlying database records having tenant and user data therein on behalf of customer organizations 121A-N (e.g., tenants of database system 150 or their affiliated users). In alternative embodiments, a client-server computing architecture may be utilized in place of database system 150, or alternatively, a computing grid, or a pool of work servers, or some combination of hosted computing architectures may be utilized to carry out the computational workload and processing that is expected of host organization 101.

The illustrated database system 150 is shown to include one or more of underlying hardware, software, and logic elements 145 that implement, for example, database functionality and a code execution environment within host organization 101. In accordance with one embodiment, database system 150 further implements databases 140 to service database queries and other data interactions with the databases 140. In one embodiment, hardware, software, and logic elements 145 of database system 150 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N may include an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a server within host organization 101. Host organization 101 may receive a variety of requests for processing by host organization 101 and its database system 150. For example, incoming requests received at the server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the server or as a stand-alone interface to receive requests packets or other requests from the client devices 130A-N. The request interface may further support the return of response packets or other replies and responses in an outgoing direction from host organization 101 to one or more client devices 130A-N.

It is to be noted that terms like “node”, “computing node”, “server”, “server device”, “cloud computer”, “cloud server”, “cloud server computer”, “machine”, “host machine”, “device”, “compute platform”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

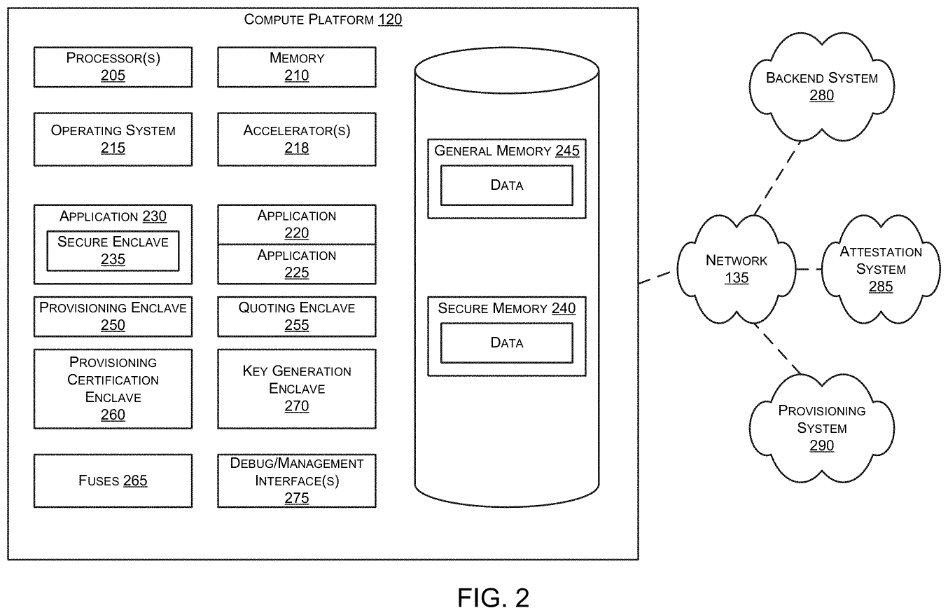

FIG. 2 is a simplified block diagram of an example system including an example compute platform 120 supporting trusted execution aware hardware debug and manageability in accordance with an embodiment. Referring to the example of FIG. 2, a compute platform 120 can include one or more processor devices 205, one or more memory elements 210, and other components implemented in hardware and/or software, including an operating system 215 and a set of applications (e.g., 220, 225, 230), and one or more accelerators 218 (e.g., a graphics processor, image processor, matrix processor, or the like). One or more of the applications may be implemented in a trusted execution environment secured using, for example, a secure enclave 235, or application enclave. Secure enclaves can be implemented using secure memory 240 (as opposed to general memory 245) and utilizing secured processing functionality of at least one of the processors (e.g., 205) of the compute platform 120 to implement private regions of code and data to provide secured or protected execution of the application. Logic, implemented in firmware and/or software of the compute platform (such as code of the CPU of the host), can be provided on the compute platform 120 that can be utilized by applications or other code local to the compute platform to set aside private regions of code and data, which are subject to guarantees of heightened security, to implement one or more secure enclaves on the system. For instance, a secure enclave can be used to protect sensitive data from unauthorized access or modification by rogue software running at higher privilege levels and preserve the confidentiality and integrity of sensitive code and data without disrupting the ability of legitimate system software to schedule and manage the use of platform resources. Secure enclaves can enable applications to define secure regions of code and data that maintain confidentiality even when an attacker has physical control of the platform and can conduct direct attacks on memory. Secure enclaves can further allow consumers of the host devices (e.g., compute platform 120) to retain control of their platforms including the freedom to install and uninstall applications and services as they choose. Secure enclaves can also enable compute platform 200 to take measurements of an application's trusted code and produce a signed attestation, rooted in the processor, that includes this measurement and other certification that the code has been correctly initialized in a trusted execution environment (and is capable of providing the security features of a secure enclave, such as outlined in the examples above).

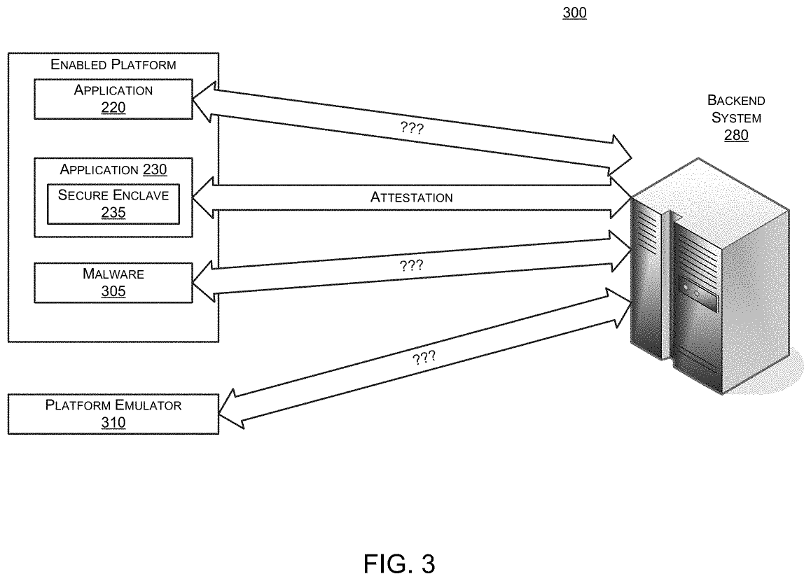

Turning briefly to FIG. 3, an application enclave (e.g., 235) can protect all or a portion of a given application 230 and allow for attestation of the application 230 and its security features. For instance, a service provider in backend system 280, such as a backend service or web service, may prefer or require that clients with which it interfaces, possess certain security features or guarantees, such that the backend system 280 can verify that it is transacting with who it the client says it is. For instance, malware (e.g., 305) can sometimes be constructed to spoof the identity of a user or an application in an attempt to extract sensitive data from, infect, or otherwise behave maliciously in a transaction with the backend system 280. Signed attestation (or simply “attestation”) can allow an application (e.g., 230) to verify that it is a legitimate instance of the application (i.e., and not malware). Other applications (e.g., 220) that are not equipped with a secure application enclave may be legitimate, but may not attest to the backend system 280, leaving the service provider in doubt, to some degree, of the application's authenticity and trustworthiness. Further, compute platforms (e.g., 200) can be emulated (e.g., by emulator 310) to attempt to transact falsely with the backend system 280. Attestation through a secure enclave can guard against such insecure, malicious, and faulty transactions.

Returning to FIG. 2, attestation can be provided on the basis of a signed piece of data, or “quote,” that is signed using an attestation key securely provisioned on the platform. Additional secured enclaves can be provided (i.e., separate from the secure application enclave 235) to measure or assess the application and its enclave 235, sign the measurement (included in the quote), and assist in the provisioning of one or more of the enclaves with keys for use in signing the quote and established secured communication channels between enclaves or between an enclave and an outside service (e.g., backend system 280, attestation system 285). For instance, one or more provisioning enclaves 250 can be provided to interface with a corresponding provisioning system to obtain attestation keys for use by a quoting enclave 255 and/or application enclave. One or more quoting enclaves 255 can be provided to reliably measure or assess an application 230 and/or the corresponding application enclave 235 and sign the measurement with the attestation key obtained through the corresponding provisioning enclave 250. A provisioning certification enclave 260 may also be provided to authenticate a provisioning enclave (e.g., 250) to its corresponding provisioning system (e.g., 120). The provisioning certification enclave 260 can maintain a provisioning attestation key that is based on a persistently maintained, secure secret on the host platform 200, such as a secret set in fuses 265 of the platform during manufacturing, to support attestation of the trustworthiness of the provisioning enclave 250 to the provisioning system 290, such that the provisioning enclave 250 is authenticated prior to the provisioning system 290 entrusting the provisioning enclave 250 with an attestation key. In some implementations, the provisioning certification enclave 260 can attest to authenticity and security of any one of potentially multiple provisioning enclaves 250 provided on the platform 200. For instance, multiple different provisioning enclaves 250 can be provided, each interfacing with its own respective provisioning system, providing its own respective attestation keys to one of potentially multiple quoting enclaves (e.g., 255) provided on the platform. For instance, different application enclaves can utilize different quoting enclaves during attestation of the corresponding application, and each quoting enclave can utilize a different attestation key to support the attestation, e.g., via an attestation system 285. Further, through the use of multiple provisioning enclaves 250 and provisioning services provided, e.g., by one or more provisioning systems 290, different key types and encryption technologies can be used in connection with the attestation of different applications and services (e.g., hosted by backend systems 280).

In some implementations, rather than obtaining an attestation key from a remote service (e.g., provisioning system 120), one or more applications and quoting enclaves can utilize keys generated by a key generation enclave 270 provided on the platform. To attest to the reliability of the key provided by the key generation enclave, the provisioning certification enclave can sign the key (e.g., the public key of a key pair generated randomly by the key generation enclave) such that quotes signed by the key can be identified as legitimately signed quotes. In some cases, key generation enclaves (e.g., 270) and provisioning enclaves (e.g., 250) can be provided on the same platform, while in other instances, key generation enclaves (e.g., 270) and provisioning enclaves (e.g., 250) can be provided as alternatives for the other (e.g., with only a key generation enclave or provisioning enclaves be provided on a given platform), among other examples and implementations.

### Adding Cycle Noise to an Enclaved Execution Environment

As described above, an enclaved execution environment (EEE) is a category of hardware-facilitated secure containers in a cloud computing system. In some examples a processing device such as a central processing unit (CPU) can use techniques including encryption, custom memory access semantics, integrity checking, and cryptographic attestation schemes to construct one or more enclaves (i.e., an enclave is an instance of an EEE). Each enclave shields one or more user applications from other enclave applications, non-enclave applications, and even privileged software such as the OS or parent hypervisor. Hence the trusted computing base (TCB) of a given enclave consists solely of the enclave itself and the underlying hardware that facilitates enclave isolation (i.e., the CPU).

Since enclaves must share resources, including memory and execution units, with the rest of the system, most EEEs support preemptive scheduling, which inhibits enclaves from monopolizing system resources. However, in some examples it may be possible for operating systems and hypervisors to abuse their privilege to execute an enclave in small increments and strategically extract secret data from the enclave through one or more side channels. These side channel attacks area form of side-channel attacks collectively referred to as interrupt-driven attacks.

In some examples, when an enclave is interrupted, the interrupt triggers an asynchronous enclave exit (AEX) that securely stores away enclave execution state (e.g., GPRs, flags, etc.). The enclave resume (ERESUME) instruction causes that state to be restored, and then allows enclave execution to continue at the point at which it was previously interrupted. Some analysis tools enable a malicious adversary to arm an advanced programmable interrupt controller (APIC) to fire an interrupt at the enclave precisely one cycle after ERESUME retires, i.e., the interrupt will arrive during execution of the first enclave instruction after the ERESUME. In some examples this allows this instruction to retire before the AEX. Hence, the adversary can single-step the enclave. Note that this approach can be applied to other EEEs on architectures where the adversary can exert similar control over the APIC, or any other controllable source for generating interrupt signals.

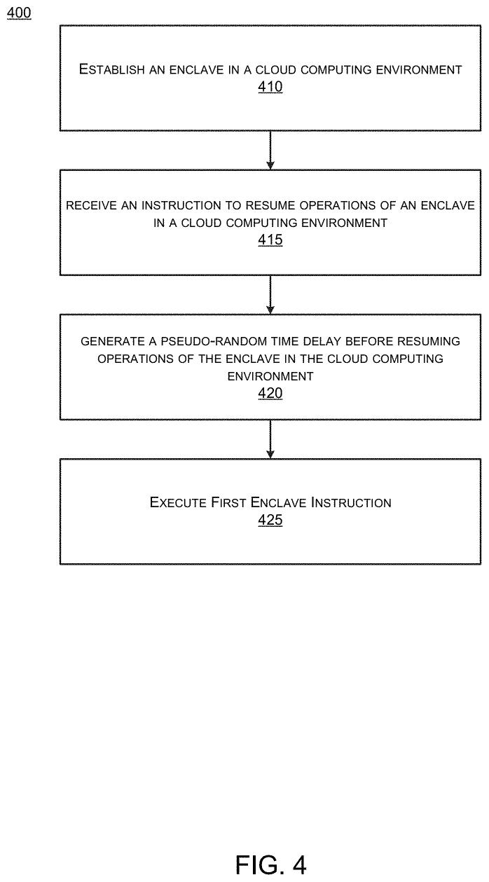

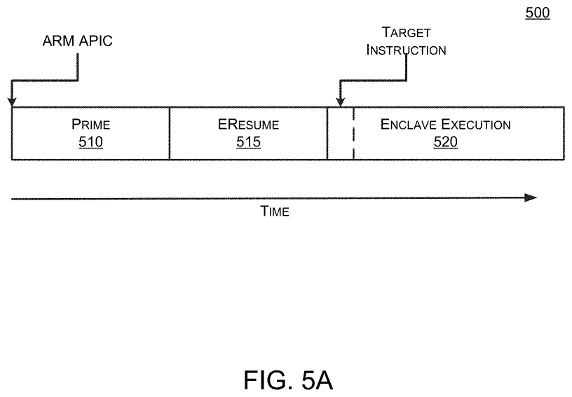

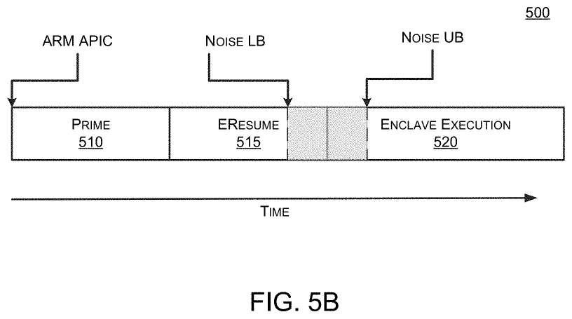

To address these and other issues, described herein are techniques to modify the ERESUME instruction to add random cycle noise, thus making all interrupt-driven attacks against EEEs more difficult. The disclosure is not exclusive to any particular architecture and could be applied to any EEE that is vulnerable to these attacks. Examples of operations and data flows will now be described with reference to FIGS. 4 and 5A-5B.

FIG. 4 is a simplified, high-level flow diagram of at least one embodiment of a method 400 for adding cycle noise to an enclaved execution environment according to an embodiment. Referring to FIG. 4, at operation 410 an enclave is established in a cloud computing environment. In some examples the compute platform may correspond to the compute platform 120 depicted in FIG. 1 and FIG. 2.

At operation 415, an instruction is received to resume operations of the enclave in the cloud computing system. For example, as described above, in some examples execution of the enclave may have been halted by an interrupt, which triggers an asynchronous enclave exit (AEX) that securely stores away enclave execution state (e.g., GPRs, flags, etc.). The instruction to resume enclave operations (ERESUME) causes that state to be restored, and then allows enclave execution to continue at the point at which it was previously interrupted.

At operation 420 a pseudo-random time delay is generated to be implemented before resuming operations of the in the cloud computing environment. There are two interesting instructions that need to be distinguished: (1) the enclave resume instruction, and (2) the first enclave instruction that will follow the enclave resume instruction. There are three points where the noise can be injected: (a) prior to the first instruction (instruction 1), (b) during the first instruction (instruction 1), or (c) after the first instruction (instruction 1) and prior to the second instruction (instruction 2). In some examples, a random number of no-op cycles may be injected at the tail end of enclave ERESUME instruction. In some examples, the number of no-op cycles can be selected from a random distribution, e.g., a uniform distribution ranging from 0 to k, where k can either be fixed by hardware, e.g., at 1000 cycles, or can be configured by the enclave developer. The boundaries 0 and k are referred to as the noise lower bound (LB) and noise upper bound (UB), respectively. If the enclave has a software AEX handler capability, then the no-op cycles can also be added by the AEX handler.

At operation 425, the instruction to resume enclave operations (ERESUME) may be executed, which causes state information to be restored, and allows enclave execution to continue at the point at which it was previously interrupted.

FIGS. 5A and 5B are diagrams illustrating instruction execution operational flows 500 in various examples of a method for adding cycle noise to an enclaved execution environment according to an embodiment. Referring to FIG. 5A, an adversary's target for the APIC interrupt is the first enclave instruction executed following the ERESUME operation 515. If the interrupt arrives while that instruction is being executed, the instruction will be allowed to retire before the AEX. Hence the enclave will progress by one architectural instruction step. To determine the APIC target, an adversary must compute equation (1):

APIC Interval=cycles_{Prime}+cycles_{ERESUME}+1 EQ 1:

The prime operation 510 is an additional requirement for some timing-based attacks, where the adversary must store the time stamp counter value, for instance. The number of cycles required to prime (i.e., cycles_Prime) and the number of cycles consumed by ERESUME (i.e., cycles_ERESUME) have little variance. Hence the adversary can determine a value for APIC Interval that will deliver the interrupt within the first enclave instruction 520.

FIG. 5B illustrates ERESUME with a pseudo-random cycle noise added. In this case, the adversary must approximate equation (2):

APIC Interval=cycles_Prime+cycles_ERESUME+unif(0,k)+1 EQ 2:

In equation (2), unif(0,k) may represent a value chosen from a closed uniform random distribution bounded by 0 and k. If an adversary assumes any value between 1 and k for unif(0,k), then the enclave will either zero-step (i.e., the interrupt will arrive during ERESUME and immediately AEX), or it may step a random number of times, thereby making it difficult to carefully constrain enclave execution, as required for many attacks. If the adversary assumes 0 as unif(0,k), then the enclave will, on average, single step 1 out of every k attempts.

Thus, introducing a pseudo-random delay raises the bar for an adversary. Other hardware mitigations may be combined with this mitigation to make it even more effective. For example, a page table entry (PTE) access (“A”) and dirty (“D”) bit may be used to determine whether the enclave has been successfully single-stepped, as opposed to being zero-stepped. If A/D-bit updates for SGX enclave code are disabled, then the adversary may not have other means to determine which 1 out of every k attempts is a successful single step

Thus, subject matter described herein makes single-stepping attacks against enclaves more difficult, and it also makes timing-based attacks against enclaves substantially more difficult. There are many attacks against enclaves that measure the amount of time taken to perform an operation within an enclave and use this timing information to derive secrets from the enclave.

### Examples

### Exemplary Computing Architecture

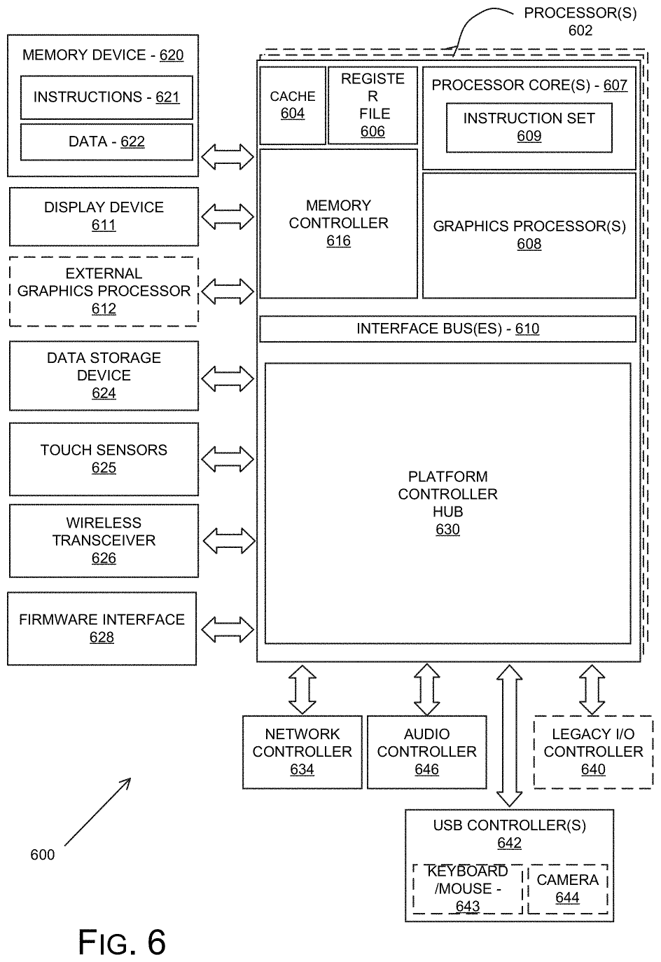

FIG. 6 is a block diagram illustrating a computing architecture which may be adapted to implement a secure address translation service using a permission table) and based on a context of a requesting device in accordance with some examples. The embodiments may include a computing architecture supporting one or more of (i) verification of access permissions for a translated request prior to allowing a memory operation to proceed; (ii) prefetching of page permission entries of an HPT responsive to a translation request; and (iii) facilitating dynamic building of the HPT page permissions by system software as described above.

In various embodiments, the computing architecture 600 may comprise or be implemented as part of an electronic device. In some embodiments, the computing architecture 600 may be representative, for example, of a computer system that implements one or more components of the operating environments described above. In some embodiments, computing architecture 600 may be representative of one or more portions or components in support of a secure address translation service that implements one or more techniques described herein.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within, a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 614. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, one or more processor(s) 602 are coupled with one or more interface bus(es) 610 to transmit communication signals such as address, data, or control signals between processor 602 and other components in the system. The interface bus 610, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 602 include an integrated memory controller 616 and a platform controller hub 630. The memory controller 616 facilitates communication between a memory device and other components of the system 600, while the platform controller hub (PCH) 630 provides connections to I/O devices via a local I/O bus.

Memory device 620 can be a dynamic random-access memory (DRAM) device, a static random-access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 execute an application or process. Memory controller hub 616 also couples with an optional external graphics processor 612, which may communicate with the one or more graphics processors 608 in processors 602 to perform graphics and media operations. In some embodiments a display device 611 can connect to the processor(s) 602. The display device 611 can be one or more of an internal display device, as in a mobile electronic device or a laptop device or an external display device attached via a display interface (e.g., DisplayPort, etc.). In one embodiment the display device 611 can be a head mounted display (HMD) such as a stereoscopic display device for use in virtual reality (VR) applications or augmented reality (AR) applications.

In some embodiments the platform controller hub 630 enables peripherals to connect to memory device 620 and processor 602 via a high-speed I/O bus. The I/O peripherals include, but are not limited to, an audio controller 646, a network controller 634, a firmware interface 628, a wireless transceiver 626, touch sensors 625, a data storage device 624 (e.g., hard disk drive, flash memory, etc.). The data storage device 624 can connect via a storage interface (e.g., SATA) or via a peripheral bus, such as a Peripheral Component Interconnect bus (e.g., PCI, PCI Express). The touch sensors 625 can include touch screen sensors, pressure sensors, or fingerprint sensors. The wireless transceiver 626 can be a Wi-Fi transceiver, a Bluetooth transceiver, or a mobile network transceiver such as a 3G, 4G, Long Term Evolution (LTE), or 5G transceiver. The firmware interface 628 enables communication with system firmware, and can be, for example, a unified extensible firmware interface (UEFI). The network controller 634 can enable a network connection to a wired network. In some embodiments, a high-performance network controller (not shown) couples with the interface bus 610. The audio controller 646, in one embodiment, is a multi-channel high definition audio controller. In one embodiment the system 600 includes an optional legacy I/O controller 640 for coupling legacy (e.g., Personal System 2 (PS/2)) devices to the system. The platform controller hub 630 can also connect to one or more Universal Serial Bus (USB) controllers 642 connect input devices, such as keyboard and mouse 643 combinations, a camera 644, or other USB input devices.

Illustrative examples of the technologies disclosed herein are provided below. An embodiment of the technologies may include any one or more, and any combination of, the examples described below.

Example 1 is a computer-implemented method, comprising receiving an instruction to resume operations of an enclave in a cloud computing environment; and generating a pseud-random time delay before resuming operations of the enclave in the cloud computing environment.

Example 2 may include the subject matter of Example 1, further comprising appending a pseudo-random number of no-operation clock cycles to the instruction to resume operations.

Example 3 may include the subject matter of Examples 1-2, wherein the pseudo-random number is chosen randomly from an arbitrary distribution.

Example 4 may include the subject matter of Examples 1-3, wherein the number of no-operation clock cycles falls between a lower bound and an upper bound.

Example 5 may include the subject matter of Examples 1˜4 wherein the upper bound is an integer value fixed by a hardware element.

Example 6 may include the subject matter of Examples 1-5, wherein the upper bound is an integer value which may be configured as a parameter.

Example 7 may include the subject matter of Examples 1-6, wherein the upper bound is configured to vary in response to one or more operating conditions of the enclave in the cloud computing environment.

Example 8 is an apparatus comprising a processor and a computer readable memory comprising instructions which, when executed by the processor, cause the processor to receive an instruction to resume operations of an enclave in a cloud computing environment; and generate a pseud-random time delay before resuming operations of the enclave in the cloud computing environment.

Example 9 may include the subject matter of Example 8, wherein the processor is to append a pseudo-random number of no-operation clock cycles to the instruction to resume operations.

Example 10 may include the subject matter of Examples 8-9 wherein the pseudo-random number is chosen randomly from an arbitrary distribution.

Example 11 may include the subject matter of Examples 8-10, wherein the number of no-operation clock cycles falls between a lower bound and an upper bound.

Example 12 may include the subject matter of Examples 8-11, wherein the upper bound is an integer value fixed by a hardware element.

Example 13 may include the subject matter of Examples 8-12, wherein the upper bound is an integer value which may be configured as a parameter.

Example 14 may include the subject matter of Examples 8-13, wherein the upper bound is configured to vary in response to one or more operating conditions of the enclave in the cloud computing environment.

Example 15 is a computer-readable storage media comprising instructions stored thereon that, in response to being executed, cause a computing device to receive an instruction to resume operations of an enclave in a cloud computing environment; and generate a pseud-random time delay before resuming operations of the enclave in the cloud computing environment.

Example 16 may include the subject matter of Example 15, further comprising instructions stored thereon that, in response to being executed, cause the computing device to append a pseudo-random number of no-operation clock cycles to the instruction to resume operations.

Example 17 may include the subject matter of Examples 15-16, wherein the pseudo-random number is chosen randomly from an arbitrary distribution.

Example 18 may include the subject matter of Examples 15-17, wherein the number of no-operation clock cycles falls between a lower bound and an upper bound.

Example 19 may include the subject matter of Examples 15-18, wherein the upper bound is an integer value fixed by a hardware element.

Example 20 may include the subject matter of Examples 15-19, wherein the upper bound is an integer value which may be configured as a parameter.

Example 21 may include the subject matter of Examples 15-20, wherein the upper bound is configured to vary in response to one or more operating conditions of the enclave in the cloud computing environment.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer-implemented method, comprising:
receiving an instruction to resume operations of an enclave in a cloud computing environment; and
generating a pseudo-random time delay before resuming operations of the enclave in the cloud computing environment.

2. The method of claim 1, further comprising:
appending a pseudo-random number of no-operation clock cycles to the instruction to resume operations.

3. The method of claim 2, wherein the pseudo-random number is chosen randomly from an arbitrary distribution.

4. The method of claim 3, wherein the number of no-operation clock cycles falls between a lower bound and an upper bound.

5. The method of claim 4, wherein the upper bound is an integer value fixed by a hardware element.

6. The method of claim 4, wherein the upper bound is an integer value which may be configured as a parameter.

7. The method of claim 6, wherein the upper bound is configured to vary in response to one or more operating conditions of the enclave in the cloud computing environment.

8. An apparatus comprising:
a processor; and
a computer readable memory comprising instructions which, when executed by the processor, cause the processor to:
receive an instruction to resume operations of an enclave in a cloud computing environment; and
generate a pseud-random time delay before resuming operations of the enclave in the cloud computing environment.

9. The apparatus of claim 8, comprising instructions which, when executed by the processor, cause the processor to:
append a pseudo-random number of no-operation clock cycles to the instruction to resume operations.

10. The apparatus of claim 9, wherein the pseudo-random number is chosen randomly from an arbitrary distribution.

11. The apparatus of claim 10, wherein the number of no-operation clock cycles falls between a lower bound and an upper bound.

12. The apparatus of claim 11, wherein the upper bound is an integer value fixed by a hardware element.

13. The apparatus of claim 11, wherein the upper bound is an integer value which may be configured as a parameter.

14. The apparatus of claim 13, wherein the upper bound is configured to vary in response to one or more operating conditions of the enclave in the cloud computing environment.

15. One or more computer-readable storage media comprising instructions stored thereon that, in response to being executed, cause a computing device to:
receive an instruction to resume operations of an enclave in a cloud computing environment; and
generate a pseud-random time delay before resuming operations of the enclave in the cloud computing environment.

16. The one or more computer-readable storage media of claim 15, further comprising instructions stored thereon that, in response to being executed, cause the computing device to:
append a pseudo-random number of no-operation clock cycles to the instruction to resume operations.

17. The one or more computer-readable storage media of claim 16, wherein the pseudo-random number is chosen randomly from an arbitrary distribution.

18. The one or more computer-readable storage media of claim 17, wherein the number of no-operation clock cycles falls between a lower bound and an upper bound.

19. The one or more computer-readable storage media of claim 18, wherein the upper bound is an integer value fixed by a hardware element.

20. The one or more computer-readable storage media of claim 18, wherein the upper bound is an integer value which may be configured as a parameter.

21. The one or more computer-readable storage media of claim 20, wherein the upper bound is configured to vary in response to one or more operating conditions of the enclave in the cloud computing environment.
